(19) United States
(12) Patent Application Publication
(10) Pub. No.: US 2012/0209674 A1
(43) Pub. Date: Aug. 16, 2012

(54) SOCIAL MARKETING INCENTIVES AND REWARDS

(75) Inventors: Eugene (John) Neystadt, Kfar-Saba (IL); Ron Karidi, Herzeliya (IL); Yitzhak Tzahi Weisfeild, Hod Hasharon (IL); Moshe Tennenholtz, Haifa (IL); Kira Radinsky, Zichron Yaakov (IL); Roy Varshavsky, Even Yehuda (IL)

(73) Assignee: Microsoft Corporation, Redmond, WA (US)

(21) Appl. No.: 13/041,452

(22) Filed: Mar. 7, 2011

Related U.S. Application Data
(60) Provisional application No. 61/441,576, filed on Feb. 10, 2011.

(51) Int. Cl. G06Q 30/00

(52) U.S. Cl. 705/14.16

(57) ABSTRACT

A social marketing system may reward and incentivize participants, and may also have a fraud detection system. The manager may create social marketing campaigns that may be simulated to determine an expected set of activities, which may be compared to an actual set of activities. A fraud detection system may detect abnormal activity and may bring the activity to a manager's attention and may also punish the participants by withholding rewards, lowering the participant's reputation, or some other punishment mechanism.

### CROSS REFERENCE TO RELATED APPLICATIONS

This application claims the benefit of and priority to U.S. Provisional Patent Application Ser. No. 61/441,576 entitled “Social Marketing Incentives and Rewards”, filed 10 Feb. 2011 by John Neystadt, et al., the entire contents of which are hereby incorporated by reference for all they teach.

### BACKGROUND

Social marketing is a broad category of marketing that uses existing relationships established between people. Many social networks exist, including online social networks through which users may communicate with each other and share various information.

### SUMMARY

A social marketing system may reward and incentivize participants, and may also have a fraud detection system. The manager may create social marketing campaigns that may be simulated to determine an expected set of activities, which may be compared to an actual set of activities. A fraud detection system may detect abnormal activity and may bring the activity to a manager's attention and may also punish the participants by withholding rewards, lowering the participant's reputation, or some other punishment mechanism.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a network environment with a social marketing campaign manager.

FIG. 2 is a flowchart of an embodiment showing a method for preparing a social network marketing campaign.

FIG. 3 is a flowchart of an embodiment showing a method for monitoring a campaign and rewarding participants.

### DETAILED DESCRIPTION

A social marketing campaign system may create social marketing campaigns that may transmit campaign materials to influencers, who may begin propagation of the campaign materials through their social networks. Many such campaigns may have a reward scheme where each person who passes information along may receive some type of reward, which may be financial rewards, reputation incentives, or other rewards.

The system may have a fraud detection mechanism that may detect when users attempt to ‘game’ the system. A fraud detection mechanism may examine user's social networks to determine a likely set of connections for such communication. The fraud detection mechanism may compare the likely set of connections to the expected set of connections to determine if the actual connections were plausible or not.

A common type of social marketing campaign may have a multi-level marketing-type reward scheme, where each person who transmits a coupon or other traceable object to another person may be rewarded. In such a scheme, a set of actual connections that are much more numerous than expected may indicate that the user may have dummy users, split identities, or other fraudulent activities.

The system may include a simulation system that may estimate the effectiveness of a particular social marketing campaign. The simulation system may be used to compare different schemes in order to select an appropriate scheme. The simulation system may also be used to create a set of likely connections for use by a fraud detection mechanism.

For the purposes of this specification and claims, the term “social network” or “online social network” may relate to any type of computerized mechanism through which persons may connect or communicate with each other. Some social networks may be applications that facilitate end-to-end communications between users in a formal social network. Other social networks may be less formal, and may consist of a user's email contact list, phone list, mailing list, or other database from which a user may initiate or receive communication.

In some cases, a social network may facilitate one-way relationships. In such a social network, a first user may establish a relationship with a second user without having the second user's permission or even making the second person aware of the relationship. A simple example may be an email contact list where a user may store contact information for another user. Another example may be a social network where a first user “follows” a second user to receive content from the second user. The second user may or may not be made aware of the relationship.

In some cases, a social network may facilitate two-way relationships. In such a social network, a first user may request a relationship with a second user and the second user may approve or acknowledge the relationship so that the two-way relationship may be established. In some social networks, each relationship within the social network may be a two-way relationship. Some social networks may support both one-way and two-way relationships.

For the purposes of this specification and claims, the term “person” or “user” may refer to both natural people and other entities that operate as a “person”. A non-natural person may be a corporation, organization, enterprise, team, or other group of people.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

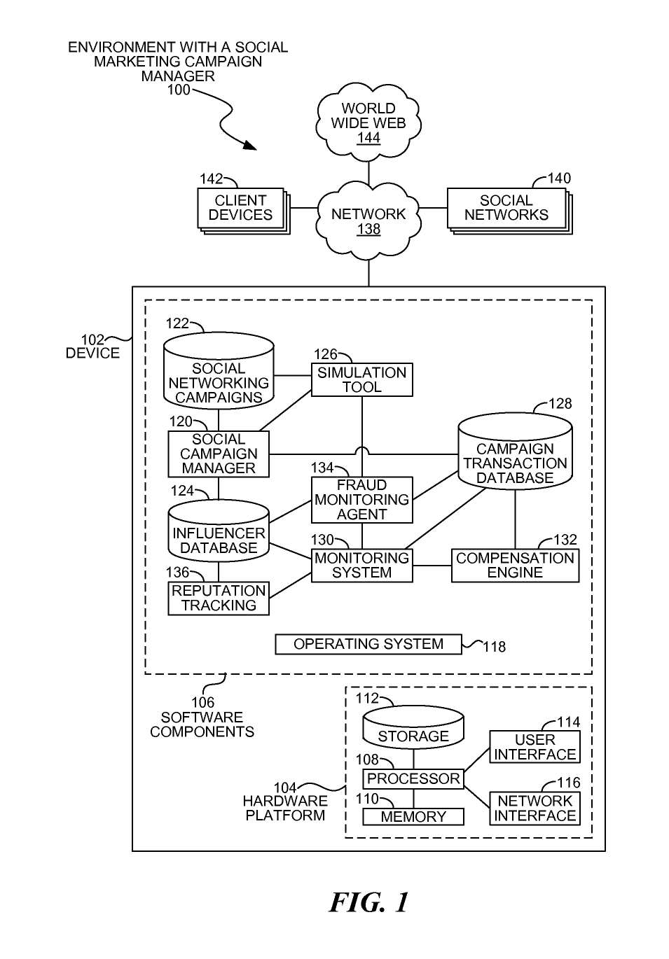

FIG. 1 is a diagram of an embodiment 100, showing an environment in which a social marketing campaign manager may operate. Embodiment 100 is a simplified example of a network environment that may include a computer system that may create, monitor, and manage marketing campaigns that operate within social networks.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 may represent a multi-faceted system for managing and operating social marketing campaigns. The social marketing campaigns may operate by sending several influential people a set of campaign materials that include a traceable object. The influential people, known as influencers, may spread the word about the campaign through various social network communications, and the traceable object may be monitored when other people perform some action relating to the campaign, such as purchasing a product, joining a group, making a contribution, or performing some other action. The system may be able to reward the influencers by financial or reputation mechanisms.

The system may include a simulation tool that may be used to compare the effectiveness of two or more social marketing campaigns as well as to help detect fraud. Fraud may be identified by comparing estimated or probable connections and actual connections between influencers and the consumers who fulfill the transactions defined in the social marketing campaigns.

The social marketing system of embodiment 100 may operate with two groups of people. A marketing professional may create and manage the campaigns while one or more influencers may actually implement the campaigns. The marketing professional may select a set of influencers and offer an opportunity to the influencers to join the campaign. After the influencers accept the invitation, the influencers may receive various campaign materials, which may include product samples, brochures, reference materials, and in some cases upfront compensation.

The influencers may spread the word about the campaign by contacting other people indirectly or directly. For example, an indirect form of contact may be to publish a weblog posting that relates to the campaign. An example of a direct form of contact may be to email information to people within the influencer's social network.

As part of the campaign, the influencer may transmit a traceable object, which may be a redeemable coupon, link to a website, or other item. The traceable object may be received by a user. In many campaigns, the user may perform some function, such as purchasing a product or performing some other action.

The types of campaigns may be any type of campaign that may have a call to action. In a retail marketing example, the campaign may entice people to purchase a specific item or to visit a specific retail outlet. In a non-profit giving campaign example, users may be enticed to donate money, items, or time to a specific organization. In a political campaign example, users may be called to become active on behalf of a candidate or political cause, such as by donating money, attending a rally, joining a movement, or some other action.

The influencers may be identified by analyzing one or more social networks as well as the person's activities on the World Wide Web. The influencers may be identified by many different manners, including crawling the World Wide Web and various social networks to automatically analyze the person's activities. In some embodiments, the influencers may be manually identified and added to an influencer database.

For example, a person who writes articles for weblogs or other publications, or a person who comments or participates in online discussions may be considered to have expertise in certain categories or contexts. Various metrics may include the number of publications on the topic, the frequency of publication, the frequency of publication compared to other people in the same or different categories, or other metrics.

Other metrics may include the importance or influence of the person's publications. The metrics may include how many times the person's works are referenced, how many subscribers may receive the person's works, the number of page views for the person's works, feedback or comments regarding the person's works, or other types of metrics.

The person's publications may be publically available publications, such as weblog postings, comments, or participation in public forums. In some embodiments, the person's publications may be private or semi-private publications, such as email messages, instant messenger messages, message transmitted within the confines of a social network, or other such messages.

In some embodiments, a person may authorize or permit access for an evaluation system to determine the person's influence or reputation. In such embodiments, a person may sign up for an evaluation of the person's relative expertise in various categories, and the system may provide credentials, offers, or other items in exchange as an enticement for the analysis.

In systems that may access information that may be considered private to the person, the person may have to expressly authorize the system to access such information. Without such access, the system may be limited to analyzing publically available information to determine a person's reputation.

A person may also have influence through their social network activities. A person who is actively involved in social networking may have more influence than people who are not involved.

Various metrics from a social network may imply a person's reputation or influence. The sheer number of relationships may be a factor, and some embodiments may analyze the type or nature of the relationships. Such embodiments may identify relationships between experts in a field as an indicator that the person may also be an expert. Such embodiments may, for example, analyze the frequency that two people interact as an indicator of the strength of the relationship. In some embodiments, two people may enjoy multiple relationships through multiple channels. In such embodiments, the duplicative nature of the relationships may indicate a strong relationship.

For many applications, the actual propagation of a person's content or opinion through a chain of people may be a strong indicator of a person's influence. An example may be a success rate or conversion rate of a person's offers to other people, such as when the person offered a discount coupon or recommended a website, game, or other item to people in their social network. The conversion rate may strongly correlate to the person's influence.

In some instances, a person's comments or publications may start or may be part of a larger conversation across multiple weblogs, chat rooms, social networks, or other methods of communication. In such a case, the person's comments may be tracked or analyzed to determine what influence, if any, the person's comments had in the overall conversation. A person who produces commentary on a topic early and frequently in a long conversation may be considered to have a higher reputation and influence that someone who comments later in the conversation.

In many cases, a person's influence with respect to the campaign system may be raised or lowered based on the person's success or failure with previous campaigns.

Various campaigns may be defined that have different rewards or enticements for the influencers to participate. In some embodiments, the influencers may be rewarded financially based on a formula or algorithm. The financial rewards may distribute a commission or other financial compensation in a manner that may entice the influencer to participate in the campaign and promote the purpose of the campaign.

In some embodiments, a campaign may provide reputation incentives for the influencers. For example, an influencer may be given a badge or other reputation indicator to show how influential or important the influencer may be within a certain sphere or topic. The badge or reputation indicator may be a credential that the influencer adds to a webpage or social network, for example. Some embodiments may include both financial and reputation incentives.

A campaign may include punishment or other disincentives to remove or discourage fraud. The punishment may be to withhold financial rewards. In some embodiments, the participant's reputation may be lowered. A lower reputation score may remove a person from future social network marketing campaigns in some embodiments.

The campaign management system may include mechanisms for monitoring the operations of the campaign. The monitoring portion may identify actions that may be taken with the traceable object, such as when the traceable object is passed from one person to another, or when the traceable object is used to perform the desired action of the campaign, such as purchasing a product or joining a political cause, for example.

In some cases, the traceable object may be a coupon that may offer a discount or other financial opportunity to purchase a particular product. For each influencer, a specific coupon may be created that contains may be traceable back to the influencer. After an influencer accepts the terms of the campaign, a traceable coupon may be created for the influencer and added to a database containing information about the campaign.

The monitoring system may be able to monitor activity with the traceable object through a website, ecommerce site, retail establishment, or other monitoring point. When the monitoring system detects the traceable object, the campaign database may be updated with the activity.

The monitoring system may issue rewards or compensation to the influencers based on the campaign definition. In some embodiments, the rewards may be issued as they are accumulated while in other embodiments, the rewards may be issued periodically or when the campaign has been closed.

Some campaigns may have a punishment scheme that may be implemented if fraud or other abnormalities are detected. The abnormalities may be detected by analyzing individual transactions or groups of transactions to determine if various fraudulent activities are being used to ‘game’ the system.

Within each transaction in a social network campaign, a chain of communications may connect an influencer with a consumer. In some cases, the chain of communications may be simple and direct, such as when the influencer contacts the consumer directly. In other cases, the chain of communications may have several people involved who may pass a traceable object from one person to another. In many social network marketing campaigns, a successful campaign may be to spread the word to as many different people as possible, so that the campaign may become viral and multiple rapidly.

Fraud may be performed by a single person having multiple online personalities and by passing traceable objects amongst the personalities or by using a large number of dummy online personas. Such activities may cause a campaign to pay out large amounts of financial rewards if such fraud is not detected.

A simulation tool may analyze the social network graphs of the influencer, the consumer, and any other participants to simulate the communications between the participants. The simulation tool may be able to estimate the likelihood of various communication paths between the various participants and compare that to the actual communication path. Based on the likelihood of the simulation, a transaction or group of transactions may be declared fraudulent.

In some embodiments, a determination of fraud may be made after a pattern or series of suspected transactions. Such embodiments may ignore a small number of suspected transactions and may only determine that fraud may be involved when a disproportionally large number of suspected transactions are identified.

In some embodiments, one or more suspected transactions may be presented to a user who may determine if indeed fraud occurred. Such a human intervention may be useful to avoid incorrectly denying a person's financial or other incentive.

The system of embodiment 100 is illustrated as being contained in a single device. In many embodiments, various software components may be implemented on many different devices. In some cases, a single software component may be implemented on a cluster of computers. Some embodiments may operate using cloud computing technologies for one or more of the components.

The system of embodiment 100 may be accessed by various client devices 142. The client devices 142 may access the system through a web browser or other application. In some embodiments, certain persons may access the system in a different manner. For example, a marketing professional may have a dedicated application through which the campaigns may be created and managed, while an influencer may use a web browser to perform some or all of the influencer tasks.

The device 102 may have a set of hardware components 104 and software components 106. The client device 102 may represent any type of device that may communicate with a live system 126.

The hardware components 104 may represent a typical architecture of a computing device, such as a desktop or server computer. In some embodiments, the client device 102 may be a personal computer, game console, network appliance, interactive kiosk, or other device. The client device 102 may also be a portable device, such as a laptop computer, netbook computer, personal digital assistant, mobile telephone, or other mobile device.

The hardware components 104 may include a processor 108, random access memory 110, and nonvolatile storage 112. The processor 108 may be a single microprocessor, multi-core processor, or a group of processors. The random access memory 110 may store executable code as well as data that may be immediately accessible to the processor 108, while the nonvolatile storage 112 may store executable code and data in a persistent state.

The hardware components 104 may also include one or more user interface devices 114 and network interfaces 116. The user interface devices 114 may include monitors, displays, keyboards, pointing devices, and any other type of user interface device. The network interfaces 116 may include hardwired and wireless interfaces through which the device 102 may communicate with other devices.

The software components 106 may include an operating system 118 on which various applications may execute.

A social campaign manager 120 may be used by a marketing professional to select, configure, distribute, and manage social marketing campaigns. The social campaign manager 120 may present one or more pre-defined social networking campaigns 122. In some embodiments, a simulation tool 126 may be able to simulate the effects of different campaigns. Some such embodiments may allow the marketing professional to change or tweak various parameters to determine how to configure a specific campaign.

The social network campaigns may operate by selecting influencers from an influencer database 124. The influencers may each receive notice for the campaigns which may include a traceable object. The traceable object may be passed in various communications to an end user or consumer of the campaign. The consumer may execute a transaction using the traceable object.

In some embodiments, the simulation tool 126 may simulate the effectiveness of a given campaign using the set of influencers selected for the campaign. The simulation tool 126 may analyze the formal and informal social networks of the influencers and provide some estimated results for the campaign.

In such an analysis, the influencer's social networks may be analyzed to determine how much redundancy or overlap there may be between each person's networks. Selecting influencers with similar social networks may be detrimental to the success of the campaign if two influencers appear to be competing against each other.

Similarly, a simulation analysis may identify certain portions of the target consumer audience that may not be covered by the campaign. In such a case, the marketing professional may identify additional influencers that may cover those portions of the target audience.

Once the campaign is defined and configured, campaign materials may be transmitted to the selected influencers, who may spread the word of the campaign through various social networks 140 and the World Wide Web 144. The campaign information may be added to a campaign transaction database 128.

As the campaign progresses, a monitoring system 130 may update the campaign transaction database 128 as the traceable objects are detected as being used. In some cases, a social network 140 may be able to indicate each time the traceable object has been communicated. In other cases, the traceable object may be identified when a consumer performs a transaction.

A transaction may be any action that the campaign may intend to cause. In a retail marketing example, the transaction may be for a consumer to purchase an item. In a political campaign, the transaction may be for a consumer to attend a rally, pledge for a cause, donate money, or perform some other action.

As the transactions are completed, a compensation engine 132 may issue rewards to the participants in a transaction. In some embodiments, only the influencer may receive rewards. Other embodiments may issue rewards to all or some of the participants in a communication chain between the influencer and the consumer.

In some embodiments, the compensation may be financial and/or reputation related. In a financial compensation scheme, a commission may be paid to the various people who may have been involved in causing the consumer to make a purchase. In a reputation compensation scheme, one or more person's reputation may be increased as the result of a successful transaction.

A person's reputation may be used to select a person for future social network campaigns, make the person eligible for free samples, give the person access to exclusive information, earn the person badges or other rank indicators, or other types of reputation compensation.

A fraud monitoring agent 134 may use various mechanisms to determine if a transaction or group of transactions may be fraudulent. The fraud monitoring agent 134 may be capable of detecting duplicate identities, dummy users, or other methods for obtaining more compensation or improper compensation.

The fraud monitoring agent 134 may compare an estimated or expected chain of communications with an actual chain of communications. When the expected and actual chains differ substantially, fraud may be detected. The chains may differ in length, for example, or may contain persons outside of the social networks of some of the participants.

In some embodiments, the fraud monitoring agent 134 may compare groups of chains of communications. The comparison may compare many different chains that would be expected to have no common links. If the chains appear to have a large number of common links, a set of dummy users or duplicate identities may be involved.

The fraud monitoring agent 134 may be configured to automatically detect fraud and deny a reward compensation scheme and implement a punishment scheme. In some cases, a human user may be alerted prior to implementing such schemes.

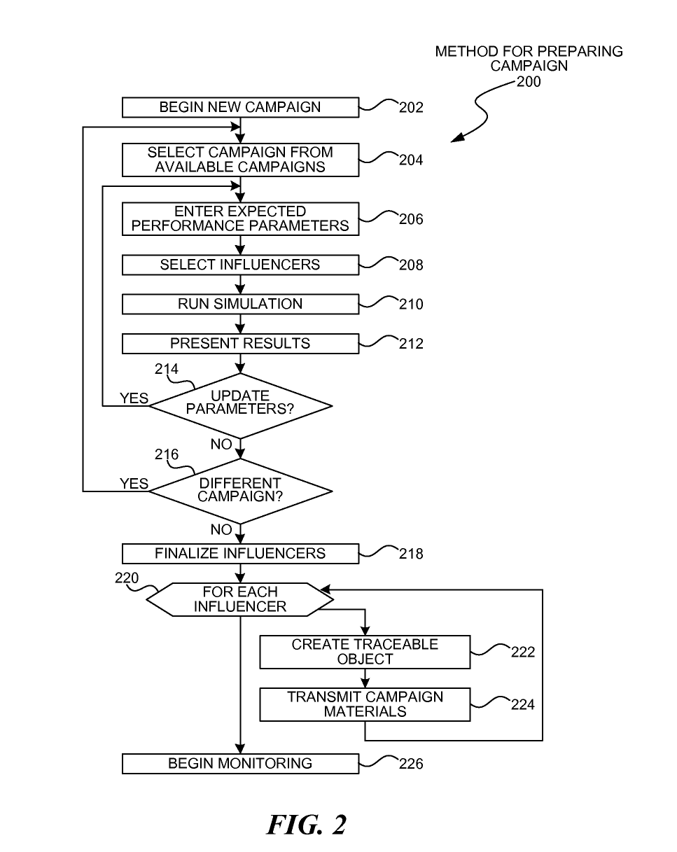

FIG. 2 is a flowchart illustration of an embodiment 200 showing a method for preparing a social network marketing campaign. Embodiment 200 is a simplified example of a method that may be performed by a social campaign manager and related components, such as the social campaign manager 120 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates an example of a method that may use a simulation tool to compare different social marketing campaigns and to select appropriate parameters for the campaigns. Once the campaigns are selected, the campaign materials may be sent to the influencers and the campaign may begin.

A new campaign may be started in block 202. A marketing professional may select a campaign from a set of available campaigns in block 204 and may enter performance parameters for the campaign in block 206.

The performance parameters may include two types of parameters. The first type may be parameters that define how the campaign may execute, such as the types and amounts of compensation, the types of traceable objects, the expected transactions, and other definitions.

The second type of parameters may define the expected performance of the campaign, such as identifying the expected social networks, the effectiveness of various types of influencers, and other parameters that may affect how a simulation may perform.

A set of influencers may be selected in block 208 and the simulation may be performed in block 210. The simulation may estimate the effectiveness of the selected campaign. In some embodiments, the simulation may use heuristics, algorithms, or other mechanisms to estimate the effectiveness of a given campaign. Some such embodiments may compare a given campaign to a historical archive of similar campaigns to estimate effectiveness.

In some embodiments, the simulation of block 210 may compare the graphs of each influencer's social networks to identify areas of overlap or areas where influencer coverage is weak or nonexistent. The results of such a simulation may be used by a marketing professional to make changes to the selected influencers.

The simulation of block 210 may determine outer boundaries for the expected results of the campaign. The outer boundaries may define criteria that are used by a fraud monitoring agent to determine whether or not a transaction or groups of transactions are potentially fraudulent.

For example, the simulation of block 210 may analyze the social networks of the influencers with respect to the target audience. Based on the simulation, a simulation may determine that an average of three connections between an influencer and consumer may be expected, for example. The simulation may determine that an outer bound may be nine connections so that a chain of connections over nine connections would be tagged as potentially fraudulent.

The outer bounds of a campaign may vary from one type of campaign to another and from one set of influencers to another. The simulation may be able to determine with statistical significance a limit to what would be normal and what would be questionable.

The results of the simulation may be presented to the marketing professional in block 212. The results may give a best case and worst case scenarios, in some embodiments, as well as maps or other graphical coverage indicators.

Based on the results, the marketing professional may wish to update the parameters in block 214, in which case the process may return to block 206. The marketing professional may wish to select a different campaign in block 208, in which case the process may return to block 204.

When the marketing professional is satisfied with the campaign and the parameters defining the campaign, the final list of influencers may be defined in block 218.

For each influencer in block 220, a traceable object may be created in block 222 and the traceable object as well as other campaign materials may be transmitted to the influencer in block 224.

Once all of the influencers have their materials, the campaign may begin and the monitoring may start in block 226.

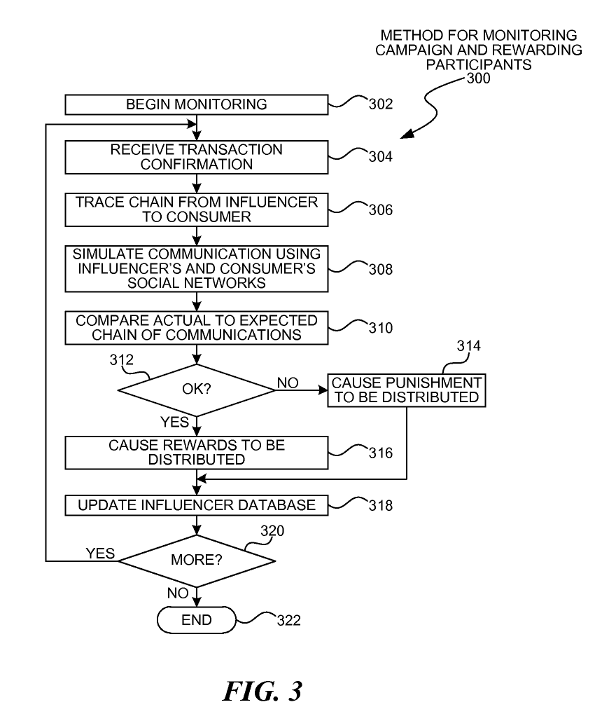

FIG. 3 is a flowchart illustration of an embodiment 300 showing a method for monitoring a campaign and rewarding participants. Embodiment 300 is a simplified example of some of the functions that may be performed by a fraud monitoring agent and other components, such as the fraud monitoring agent 134 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates one example of how a campaign may be monitored and fraud may be identified. The fraud detection of embodiment 300 may compare estimated or expected communication chains with actual communication chains. A communication chain may be the various connections between an influencer and a consumer. In many social network marketing campaigns, a traceable object may be passed from one person to another in the form of a coupon or other object.

Monitoring a campaign may begin in block 302.

A transaction confirmation may be received in block 304. In a typical embodiment, the transaction confirmation may be received when a user redeems a coupon containing a traceable object, lands on a website containing the traceable object, or performs some other object of the campaign.

Based on the transaction confirmation, the communication chain may be traced from the influencer to the consumer in block 306. Such a communication chain may be the actual communication chain for the transaction.

In block 308, a simulation of an expected communication chain may be performed. The actual and expected communication chains may be compared in block 310.

If the comparison is OK in block 312, the rewards may be distributed in block 314 to the various participants. If the comparison is not OK in block 314, a punishment scheme may be implemented in block 316.

Based on the success or failure of the transaction, the influencer database may be updated in block 318.

When another transaction is received in block 320, the process may return to block 304, otherwise the process may end in block 322.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a campaign manager operable on a first computer processor, said campaign manager that:
receives a first social network campaign definition comprising an incentive scheme that defines a transaction completion criteria that is performed by a consumer and a reward compensation that is given to an influencer who communicates within one or more social networks with said consumer regarding a transaction, said first social network campaign definition comprising a traceable object transmitted through an online social network;
determines an outer bounds for said transaction conditions;
creates a first social network campaign comprising said outer bounds for said transaction conditions; and
transmits at least one of said traceable objects to each of a plurality of said influencers;
a monitoring component that:
detects that said transaction completion criteria has been met by a first consumer in a first transaction; and
detects that said transaction completion criteria has been met by a second consumer in a second transaction; and
a fraud monitoring agent that:
analyzes said first transaction to determine that said first transaction is within said outer bounds for said transaction conditions and causes said reward compensation to be performed for said first transaction; and
analyzes said second transaction to determine that said second transaction is outside said outer bounds for said transaction conditions and causes said reward compensation not to be performed for said second transaction.

2. The system of claim 1, said fraud monitoring agent that further:
causes a penalty to be assessed after analyzing said second transaction.

3. The system of claim 2, said fraud monitoring agent that further:
identifies at least one person associated with said second transaction for said penalty.

4. The system of claim 3, said penalty being a reputation penalty.

5. The system of claim 1 further comprising:
a campaign simulator that:
receives said first social network campaign;
receives a first set of parameters for said first social network campaign, said first set of parameters being an expected set of transaction conditions;
simulates said first social network campaign to determine said outer bounds for said transaction conditions.

6. The system of claim 5, said campaign simulator that further:
presents a first set of simulated results to a user;
receives an updated set of parameters from said user; and
simulates said first social network campaign using said updated set of parameters.

7. The system of claim 1, said claim manager that further:
presents a plurality of social network campaigns to a user; and
receives user input that identifies said first social network campaigns.

8. The system of claim 1, said monitoring component that:
determines a message spread factor for said first social network campaign.

9. The system of claim 8, said monitoring component that:
determines a message stickiness factor for said first social network campaign.

10. The system of claim 9, said monitoring component that determines said message spread factor for at least two social networks.

11. A method comprising:
creating a social marketing campaign comprising traceable objects, said social marketing campaign further comprising a reward compensation scheme, said reward compensation scheme being performed after a consumer performs a transaction with a traceable object;
to each of a plurality of influencers, transmitting one of said traceable objects;
tracing a first traceable object from a first influencer to a first consumer, said first consumer having performed a first transaction to determine a first chain of communication between said first influencer and said first consumer;
determining a first expected chain of communication by examining a first social network to which said first influencer belongs; and
comparing said first expected chain of communication with said first chain of communication to determine that said first chain of communication is legitimate and causing said reward compensation scheme to be executed.

12. The method of claim 11 further comprising:
tracing a second traceable object from a second influencer to a second consumer, said second consumer having performed a second transaction to determine a second chain of communication between said second influencer and said second consumer;
determining a second expected chain of communication by examining a second social network to which said second influencer belongs; and
comparing said second expected chain of communication with said second chain of communication to determine that said second chain of communication is not legitimate and causing said reward compensation scheme not to be executed.

13. The method of claim 12, said social marketing campaign further comprising a punishment scheme.

14. The method of claim 13, said punishment scheme being executed for said second influencer.

15. The method of claim 14, said punishment scheme comprising lowering a reputation index for said second influencer.

16. The method of claim 15, said second chain of communication comprising a larger number of people than said second expected chain of communication.

17. The method of claim 15, said second chain of communication comprising at least one person having a known fraudulent identification.

18. A system comprising:
a campaign manager operable on a first computer processor, said campaign manager that:
receives a first social network campaign definition comprising an incentive scheme that defines a transaction completion criteria that is performed by a consumer and a reward compensation that is given to an influencer who communicates within one or more social networks with said consumer regarding a transaction, said first social network campaign definition comprising a traceable object transmitted through an online social network;
receives a set of parameters for said first social network campaign definition, said set of parameters defining an expected set of transaction conditions;
determines an outer bounds for said transaction conditions through simulating communication propagation through said one or more social networks for each of a plurality of influencers;
creates a first social network campaign comprising said outer bounds for said transaction conditions; and
transmits at least one of said traceable objects to said each of a plurality of said influencers;
a monitoring component that:
detects that said transaction completion criteria has been met by a first consumer in a first transaction; and
detects that said transaction completion criteria has been met by a second consumer in a second transaction; and
a fraud monitoring agent that:
analyzes said first transaction to determine that said first transaction is within said outer bounds for said transaction conditions and causes said reward compensation to be performed for said first transaction; and
analyzes said second transaction to determine that said second transaction is outside said outer bounds for said transaction conditions and causes said reward compensation not to be performed for said second transaction.

19. The system of claim 18, said fraud monitoring agent that further:
causes a penalty to be assessed after analyzing said second transaction.

20. The system of claim 19, said fraud monitoring agent that further:
identifies at least one person associated with said second transaction for said penalty.
